(19) United States
(12) Patent Application Publication
(10) Pub. No.: US 2022/0132209 A1
(43) Pub. Date: Apr. 28, 2022

(54) METHOD AND SYSTEM FOR REAL TIME FILTERING OF INAPPROPRIATE CONTENT FROM PLURALITY OF VIDEO SEGMENTS

(71) Applicant: Smile Internet Technologies Private Limited, Gurugram (IN)

(72) Inventors: Siddharth PURI, NOIDA (IN); Vaibhav PANDEY, Delhi (IN); Arpit GOEL, Delhi (IN); Daman ARORA, Jalandhar (IN)

(73) Assignee: Smile Internet Technologies Private Limited, Gurugram (IN)

(21) Appl. No.: 17/570,318

(22) Filed: Jan. 6, 2022

Related U.S. Application Data
(63) Continuation of application No. 17/008,451, filed on Aug. 31, 2020, now abandoned.

(51) Int. Cl. H04N 21/4545; H04N 21/454; H04N 21/4402; H04N 21/466

(52) U.S. Cl. CPC H04N 21/4545; H04N 21/4662; H04N 21/4402; H04N 21/4542

(57) ABSTRACT

The present disclosure provides a computer-implemented method and system for real-time filtering of an inappropriate content from a plurality of video segments. The method includes a first step of receiving multimedia content. In addition, the method includes another step of segmenting the multimedia content in real-time. Further, the method includes yet another step of identifying the inappropriate content in real-time. Furthermore, the method includes yet another step of filtering of the plurality of video segments in real-time. Moreover, the method includes yet another step of displaying an appropriate video content in real-time.

### CROSS-REFERENCE TO RELATED APPLICATIONS

This application is a continuation of U.S. patent application Ser. No. 17/008,451, filed Aug. 31, 2020, which application is incorporated herein by reference in its entirety for all purposes.

### TECHNICAL FIELD

The present disclosure relates to the field of video segmentation. More specifically, the present disclosure relates to a system and method for real time filtering of an inappropriate content from a video segments.

### INTRODUCTION

With the advent of online multimedia revolution along with sudden rise in network bandwidth in recent years, the internet usage has grown leaps and bounds. Most people today are connected to multimedia channels through the internet. The multimedia channels include facebook, instagram, twitter, snapchat, you tube and hotstar. These multimedia channels provide multimedia contents to users. Nowadays, some of the multimedia contents include an inappropriate content such as nude images, sexual content, nude videos and violent scenes. Many users on the multimedia channels do not appreciate the inappropriate content on the multimedia channels. The reason for not appreciating the inappropriate contents is different cultures, different regions and gender. These inappropriate contents are creating harmful impact on adults and teenagers. There is a need to improvise the multimedia channels in terms of the multimedia contents containing the inappropriate content.

In light of the foregoing discussion, there exists a need for a new and improved system which overcomes the above-cited drawbacks of conventional systems.

### SUMMARY

In a first example, a computer-implemented method is provided. The computer-implemented method for real time filtering of an inappropriate content from a plurality of video segments. The method includes a first step of receiving one or more multimedia content at a video filtration system with a processor. In addition, the method includes another step of segmenting the one or more multimedia content in real-time at the video filtration system with the processor. Further, the method includes yet another step of identifying the inappropriate content in real-time at the video filtration system with the processor. Furthermore, the method includes yet another step of filtering the inappropriate content in real-time at the video filtration system with the processor. Moreover, the method includes yet another step of displaying the appropriate video content in real-time at the video filtration system with the processor. The one or more multimedia content is received from one or more input devices. The one or more multimedia content is segmented into the plurality of video segments. The one or more multimedia content is segmented into the plurality of video segments based on one or more parameters. The plurality of video segments is ranked based on the one or more parameters. The inappropriate content is identified from the plurality of video segments. The inappropriate content is identified using machine learning algorithms. The inappropriate content is filtered out using a detection model. The detection model filters the inappropriate content based on one or more pre-defined factors. The filtering of the inappropriate content from the plurality of video segments facilitates generation of an appropriate video content. The appropriate video content is displayed on one or more multimedia channels. The appropriate video content is displayed based on one or more requirements of the one or more multimedia channels.

In an embodiment of the present disclosure, the one or more input devices include at least one of keyboard, joystick, mouse and digital camera.

In an embodiment of the present disclosure, the one or more multimedia content includes at least one of text, audio, video, animation and graphics interface format (GIF).

In an embodiment of the present disclosure, the one or more parameters include an audio continuity, a video continuity and an intersection of the audio continuity and the video continuity.

In an embodiment of the present disclosure, the inappropriate content includes nude video content, nude images, inappropriate audio content, violent video content, religiously disrespectful content, political influential content, cultural norms and gender discriminatory content.

In an embodiment of the present disclosure, the one or more pre-defined factors include at least one of geographical location, age and community.

In an embodiment of the present disclosure, the machine learning algorithms include at least one of linear regression, logistic regression, random forest, decision tree, and K-nearest neighbor.

In an embodiment of the present disclosure, the video filtration system includes adaptive-learning of the detection model. In addition, the detection model adapts learning to filter-out the inappropriate content from the plurality of video segments based on training dataset.

In an embodiment of the present disclosure, the one or more requirements of the one or more multimedia channels include at least one of an orientation of the appropriate content, an aspect ratio of the appropriate content and a duration of the appropriate content.

In an embodiment of the present disclosure, the video filtration system includes sub-filtering of the plurality of video segments. In addition, the sub-filtering of the plurality of video segments is effectuated to target a plurality of users at particular geographical location. In addition, the sub-filtering is performed based on presence of naked-skin in the plurality of video segments.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for real time filtering of an inappropriate content from a plurality of video segments. The method includes a first step of receiving one or more multimedia content at a video filtration system. In addition, the method includes another step of segmenting the one or more multimedia content in real-time at the video filtration system. Further, the method includes yet another step of identifying the inappropriate content in real-time at the video filtration system. Furthermore, the method includes yet another step of filtering the inappropriate content in real-time at the video filtration system. Moreover, the method includes yet another step of displaying the appropriate video content in real-time at the video filtration system. The one or more multimedia content is received from one or more input devices. The one or more multimedia content is segmented into the plurality of video segments. The one or more multimedia content is segmented into the plurality of video segments based on one or more parameters. The plurality of video segments is ranked based on the one or more parameters. The inappropriate content is identified from the plurality of video segments. The inappropriate content is identified using machine learning algorithms. The inappropriate content is filtered out using a detection model. The detection model filters the inappropriate content based on one or more pre-defined factors. The filtering of the inappropriate content from the plurality of video segments facilitates generation of an appropriate video content. The appropriate video content is displayed on one or more multimedia channels. The appropriate video content is displayed based on one or more requirements of the one or more multimedia channels.

In a third example, a non-transitory computer-readable storage medium is provided. The non-transitory computer-readable storage medium encodes computer executable instructions. The computer executable instructions are executed by at least one processor to perform a method for real time filtering of an inappropriate content from a plurality of video segments. The method includes a first step of receiving one or more multimedia content at a computing device. In addition, the method includes another step of segmenting the one or more multimedia content in real-time at the computing device. Further, the method includes yet another step of identifying the inappropriate content in real-time at the computing device. Furthermore, the method includes yet another step of filtering the inappropriate content in real-time at the computing device. Moreover, the method includes yet another step of displaying the appropriate video content in real-time at the computing device. The one or more multimedia content is received from one or more input devices. The one or more multimedia content is segmented into the plurality of video segments. The one or more multimedia content is segmented into the plurality of video segments based on one or more parameters. The plurality of video segments is ranked based on the one or more parameters. The inappropriate content is identified from the plurality of video segments. The inappropriate content is identified using machine learning algorithms. The inappropriate content is filtered out using a detection model. The detection model filters the inappropriate content based on one or more pre-defined factors. The filtering of the inappropriate content from the plurality of video segments facilitates generation of an appropriate video content. The appropriate video content is displayed on one or more multimedia channels. The appropriate video content is displayed based on one or more requirements of the one or more multimedia channels.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment for real-time filtering of an inappropriate content from a plurality of video segments, in accordance with various embodiments of the present disclosure;

FIG. 2 illustrates a flow chart of a method for real-time filtering of the inappropriate content from the plurality of video segments, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

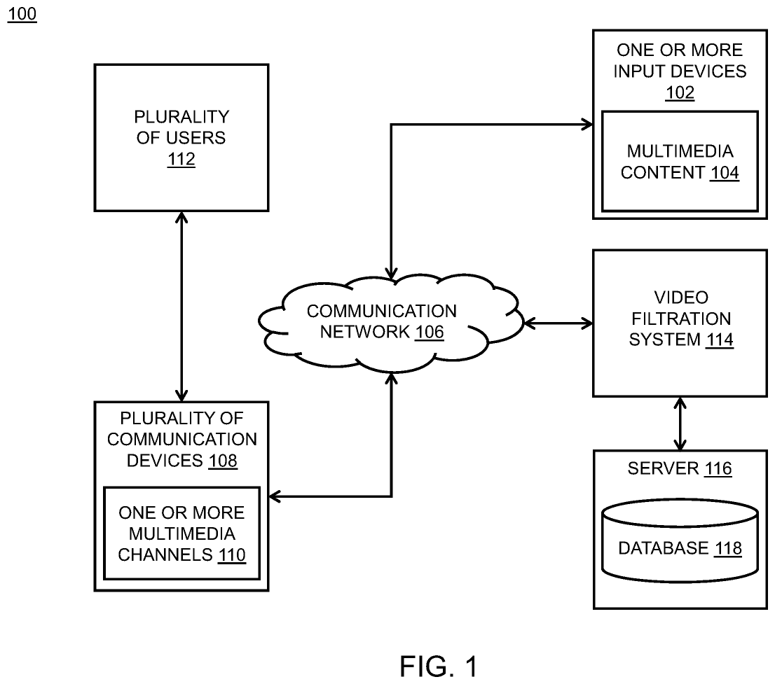

FIG. 1 illustrates a general overview of an interactive computing environment 100 for performing real-time filtering of an inappropriate content from a plurality of video segments, in accordance with various embodiments of the present disclosure. The interactive computing environment 100 illustrates an environment suitable for an interactive reception and analysis of one or more multimedia content 104 for creating the plurality of video segments. The interactive computing environment 100 is configured to provide a setup for creating the plurality of video segments. The interactive computing environment 100 is configured to create and filter the plurality of video segments. The interactive computing environment 100 includes one or more input devices 102, a one or more multimedia content 104, a communication network 106, a plurality of communication devices 108 and one or more multimedia channels 110. In addition, the interactive computing environment 100 includes a video filtration system 114, a server 116 and a database 118.

The interactive computing environment 100 includes the plurality of users 112. In an example, each user of the plurality of users may be a user or an individual who accesses various social media platforms to view social media content. In an embodiment of the present disclosure, the plurality of users 112 is associated with the corresponding plurality of communication devices 108. In an embodiment of the present disclosure, the plurality of users 112 is an owner of the corresponding plurality of communication devices 108. Moreover, the plurality of users 112 may be any person or individual who access the corresponding the plurality of communication devices 108. Also, the one or more multimedia channels 110 is associated with the plurality of communication devices 108. The above stated elements of the interactive computing environment 100 operate coherently and synchronously to create and filter the plurality of video segments.

The interactive computing environment 100 includes the one or more input devices 102. In general, input device refers to a hardware device that transfers data to computer. In an embodiment of the present disclosure, the one or more input devices 102 receives the one or more multimedia content 104 from one or more video sources. In addition, the one or more video sources includes one or more databases. In an example, one or more databases includes amazon web services, content distribution network, datacenters and the like. In an example, “YouTube” stores video content in datacenters and content distribution network. In another example, “Netflix” stores data in combination of hardware devices crammed together in a server. The one or more input devices 102 are associated with the video filtration system 114. In an embodiment of the present disclosure, the one or more input devices 102 transfer the one or more multimedia content 104 to the video filtration system 114. In an embodiment of the present disclosure, the one or more input devices 102 includes but may not be limited to at least one of keyboard, mouse, scanner, digital camera, microphone, digitizer and joystick. In an example, the one or more input devices provides input to video filtration system in the form of text, audio, video and the like. In general, multimedia content uses combination of different content forms such as text, audio, images, animations, video and interactive content. In an embodiment of the present disclosure, the one or more multimedia content 104 includes but may not be limited to text, audio and video. In an example, a user X is associated with an electronic device (say, a laptop). The user X receives a multimedia content in form of a text embedded with information. In addition, the user X transforms the text into video segments using an electronic device. Further, the video segments are broadcasted on social media channels.

In an embodiment of the present disclosure, the one or more multimedia content 104 undergoes video segmentation process. The one or more multimedia content 104 include one or more audio-video content, one or more video content and the like. In addition, the video segmentation process breaks the one or more multimedia content 104 into the plurality of video segments using the video filtration system 114. In general, video segmentation is a process of partitioning a digital video into multiple segments. In an embodiment of the present disclosure, multiple video segments can be created out of multiple multimedia content. In an example, 3 video segments can be created from each of the 5 videos which will give 15 video segments. In an embodiment of the present disclosure, the one or more multimedia content 104 is segmented into the plurality of video segments based on one or more parameters. In an embodiment of the present disclosure, the one or more parameters include an audio continuity. In another embodiment of the present disclosure, the one or more parameters include a video continuity. In yet another embodiment of the present disclosure, the one or more parameters include an intersection of the audio continuity and the video continuity. The audio continuity refers to checking of continuity in an audio content present in the plurality of video segments. The video continuity refers to checking of continuity in a video content present in the plurality of video segments. The intersection of the audio continuity and the video continuity refers to seamless intersection of the audio content with respective video content. In an example, a user A associated with an electronic device (say, a laptop) receives a movie trailer. In addition, the electronic device splits the movie trailer in number of video segments (say, twelve). Further, the electronic device splits the movie trailer using number of algorithms. Furthermore, the number of algorithms ensures complete dialogue present in number of video segments, complete scene present in the number of video segments and complete scene present with dialogue in number of video segments. In another example, a user B associated with an electronic device (say, a laptop) receives an audio trailer. In addition, the electronic device splits the audio trailer in number of video segments (say, ten). Further, the electronic device splits the audio trailer using number of algorithms. Furthermore, the number of algorithms ensures complete dialogue present in the number of video segments. In an embodiment of the present disclosure, the plurality of video segments is selected based on the one or more parameters. In an example, video segments is selected by ensuring continuity of dialogue in the video segments. In another example, the video segments are selected by ensuring the continuity of video scene in the video segments. In yet another example, the video segments are selected by ensuring the continuity of dialogue with video scene in the video segments.

The interactive computing environment 100 includes the communication network 106. The communication network 106 is associated with the plurality of communication devices 108. In an embodiment of the present disclosure, the communication network 106 transfers the plurality of video segments to the plurality of communication devices 108 using the video filtration system 114. In general, communication devices are hardware devices capable of transmitting data. The plurality of communication devices 108 is hardware devices capable of transmitting the plurality of video segments on the one or more multimedia channels 110 using the communication network 106.

The interactive computing environment 100 includes the plurality of communication devices 108. In an embodiment of the present disclosure, the plurality of communication devices 108 includes but may not be limited to smart phone, tablet, laptop and personal digital assistant. The plurality of communication devices 108 is associated with the one or more multimedia channels 110 through the communication network 106. The communication network 106 provides medium for the plurality of communication devices 108 to receive the plurality of video segments. Also, the communication network 106 provides network connectivity to the plurality of communication devices 108 using a plurality of methods. The plurality of methods is used to provide network connectivity to plurality of communication devices 108 includes 2G, 3G, 4G, Wi-Fi, BLE, LAN, VPN, WAN and the like. In an example, the communication network includes but may not be limited to a local area network, a metropolitan area network, a wide area network, a virtual private network, a global area network and a home area network.

Further, the interactive computing environment 100 includes the one or more multimedia channels 110. In an example, the one or more multimedia channels includes but may not be limited to WhatsApp, Facebook, Instagram, LinkedIn, P interest, WeChat, YouTube, Twitter, Skype, Google+, Snapchat, Hike and Telegram. The one or more multimedia channels 110 may not be limited to the above mentioned channels. In general, each multimedia channel provides social media content to users. In an embodiment of the present disclosure, the plurality of users 112 access the one or more multimedia channels 110. In addition, the plurality of video segments are displayed on the one or more multimedia channels 110 based on one or more requirements. Further, the one or more requirements of the one or more multimedia channels 110 includes but may not be limited to an aspect ratio, an orientation and a duration.

The interactive computing environment 100 includes the video filtration system 114. The video filtration system 114 is associated with the plurality of communication devices 108 through the communication network 106. In addition, the plurality of communication devices 108 is associated with the corresponding plurality of users 112 through the one or more multimedia channels 110. In an embodiment of the present disclosure, the video filtration system 114 performs filtering of the plurality the video segments. In addition, the video filtration system 114 receives the one or more multimedia content 104 on the plurality of communication devices 108 through the communication network 106. Further, the one or more multimedia content 104 are received in one or more formats. Furthermore, the one or more formats include text, audio, video, animation and gif and the like. Also, the one or more multimedia content 104 is received from the one or more input devices 102. Furthermore, the one or more input devices 102 include keyboard, mouse, scanner, digital camera, microphone, digitizer, joystick and the like. In an example, the user X associated with the electronic device (say, a mobile) receives a multimedia content in form of graphics interchange format.

The video filtration system 114 performs segmentation of the one or more multimedia content 104. In addition, the segmentation of the one or more multimedia content 104 generates a plurality of video segments based on one or more of parameters. Further, the one or more parameters include a video continuity, an audio continuity and an intersection of the audio continuity and the video continuity. In an embodiment of the present disclosure, the plurality of video segments ensures complete dialogue present in the plurality of video segments. In another embodiment of the present disclosure, the plurality of continuous content ensures complete scene present in the plurality of video segments. In yet another embodiment of the present disclosure, the plurality of video segments ensures complete scene present with dialogue in the plurality of video segments. In addition, the plurality of video segments is created based on the one or more parameters. In an example, segments of a movie trailer are combined based on the intersection of the audio continuity and video continuity ensuring continuity of dialogue with video scene in the segments.

Further, the video filtration system 114 performs ranking of each of the plurality of video segments based on the one or more parameters. In addition, the one or more parameters include the video continuity, the audio continuity and the intersection of the audio continuity and the video continuity. In an example, a user A is associated with the electronic device (say, a laptop) accesses a video based platform and comes across multiple videos for the user A to watch. The multiple videos may or may not be video segments created by the video filtration system 114. The video filtration system 114 is operated by an administrator in real time. The video filtration system 114 receives one or more videos in real time from one or more sources. Let's say, the video filtration system 114 receives a lengthy video of a movie trailer. In addition, the video filtration system 114 splits the movie trailer in number of video segments (say, ten). Further, the video filtration system 114 splits the movie trailer using number of algorithms. Furthermore, the number of algorithms ensures complete scene present with dialogue in the plurality of video segments is ranked first.

In an embodiment of the present disclosure, the plurality of video segments may or may not include any inappropriate content. In addition, the inappropriate content includes nude video content, nude images, vulgar images, inappropriate audio content, violent video content, religiously disrespectful content, gender discriminatory content, cultural norms, political influential content and the like. In an example, a segment S1 of an adult movie M1 is defined inappropriate based on nudity. In another example, a segment S2 of an audio is defined inappropriate based on inappropriate audio content. In yet another example, a segment S3 of the comedy movie M2 is defined inappropriate based on the derogatory remarks on the religious book B1. In yet another example, a segment S4 of the action movie M3 is categorized inappropriate based on violent content. In yet another example, a segment S5 of a feminism movie M4 is defined inappropriate based on gender inequality. In an example, video segment S1 influences people during election for selection of political leader L1 for country X is categorized inappropriate content and filtered out. In another example, video segment S2 has the inappropriate content that effects particular religion is categorized inappropriate content and filtered out.

In an embodiment of the present disclosure, the video filtration system 114 utilizes enhanced NSFW filter to detect body skin exposure. In an example, video segment S3 has content exposing shoulders or legs is categorized as inappropriate content and filtered out in country X.

The video filtration system 114 identifies the inappropriate content from the plurality of video segments. In addition, the video filtration system 114 identifies the inappropriate content from the plurality of video segments based on brand guidelines. In an example, VIU is an over the top video on demand service. In addition, the video filtration system 114 facilitates identification of the inappropriate content on VIU. In addition, the inappropriate content from the plurality of video segments is identified using machine learning algorithms. In addition, the meaning learning algorithms includes linear regression, logistic regression, random forest, decision tree, K-nearest neighbor and the like. In general, machine learning algorithms are used to develop different models for datasets. In addition, datasets are divided into training dataset and test dataset. Further, training dataset is used to train the model that is developed using the machine learning algorithm. Furthermore, test dataset is used to test the efficiency and accuracy of the developed model.

Moreover, the video filtration system 114 performs filtration of the inappropriate content from the plurality of video segments. Also, the inappropriate content is filtered out using a detection model. Also, the detection model is trained to filter out the inappropriate content using training dataset. Also, the training dataset includes nude video content, nude images, inappropriate audio content, violent video content, religiously disrespectful contents, gender discriminatory contents and the like. Also, the detection model adaptively learns to filter out the inappropriate content from the plurality of video segments using training datasets. Also, the detection model filters the inappropriate content from the plurality of video segments based on one or more pre-defined factors. Also, the one or more pre-defined factors include geographical location, age, community and the like. In an example, for a geographical location G1, the detection model filters the inappropriate content from the number of video segments (say, ten) based on pre-defined threshold limit. In addition, the pre-defined threshold limit is either zero value or one value. Further, the pre-defined threshold limit with zero value refers to the appropriate content. Furthermore, the pre-defined threshold limit with one value refers to the inappropriate content. Moreover, the detection model skips the inappropriate content from the number of video segments for a community C1 of age group of 10 years to 20 years living in geographical location G1 having the pre-defined threshold limit with one value.

In another example, for a geographical location G2, the detection model filters the inappropriate content from the number of video segments (say, ten) based on pre-defined threshold limit. In addition, the pre-defined threshold limit is either zero value or one value. Further, the pre-defined threshold limit with zero value refers to the appropriate content. Furthermore, the pre-defined threshold limit with one value refers to the inappropriate content. Moreover, the detection model skips the inappropriate content from the number of video segments for a community C2 of age group of 10 years to 20 years living in geographical location G2 having the pre-defined threshold limit with one value.

In an embodiment of the present disclosure, the filtering of the inappropriate content from the plurality of video segments facilitates generation of an appropriate video content. In addition, the video filtration system 114 performs sub-filtering of the plurality of video segments. Further, the sub-filtering is performed for filtering of naked-skin once the presence of naked-skin is detected in the plurality of video segments. Furthermore, the sub-filtering is performed in order to skip or blur the naked-skin in the plurality of video segments. Furthermore, the sub-filtering is done by the detection model at the video filtration system 114 based on the one or more pre-defined factors. Moreover, the one or more pre-defined factors include the geographical location. In an example, for a geographical location G3, the detection model performs the sub-filtering of the presence of naked-skin from the number of video segments (say, ten) based on pre-defined threshold limit. In addition, the pre-defined threshold limit is either zero value or one value. Further, the pre-defined threshold limit with zero value refers to absence of the naked-skin in the plurality of video segments. Furthermore, the pre-defined threshold limit with one value refers to presence of naked-skin in the plurality of video segments. Moreover, the detection model skips the presence of naked-skin from the number of video segments for a community C3 of age group of 10 years to 20 years living in geographical location G3 having the pre-defined threshold limit with one value.

In an embodiment of the present disclosure, the detection model performs filtering of the inappropriate content from the plurality of video segments. In addition, the detection model performs sub-filtering of the presence of naked-skin in the plurality of video segments. Further, the detection model facilitates the generation of the appropriate video content. Furthermore, the detection model displays the appropriate video content to the video filtration system 114. Moreover, the video filtration system 114 displays the appropriate content on the one or more multimedia channels 110 in real time. The appropriate video content can be viewed by the plurality of users 112 over the corresponding plurality of communication devices 114. In an embodiment of the present disclosure, video filtration system 114 targets the appropriate video content suitable for appropriate users to watch based on the pre-defined factors. Also, the one or more multimedia channels 110 include Facebook, YouTube, Snapchat, Pinterest, WeChat, Instagram, Hike, Whatsapp, Linkedin, Twitter, Skype, Google+, and the like. In an embodiment of the present disclosure, the appropriate video content displayed on the multimedia channels 114 may or may not be a video segment.

Further, the interactive computing environment 100 includes the server 116. In an embodiment of the present disclosure, the video filtration system 114 is connected with the server 116. In another embodiment of the present disclosure, the server 116 is part of the video filtration system 114. The server 116 handles each operation and task performed by the video filtration system 114. The server 116 stores one or more instructions for performing various operations of the video filtration system 114. In an embodiment of the present disclosure, the server 116 is a cloud server. The cloud server is built, hosted and delivered through a cloud computing platform. In general, cloud computing is a process of using remote network server that are hosted on the internet to store, manage, and process data. Further, the server 116 includes the database 118.

The interactive computing environment 100 includes the database 118. The database 118 is used for storage purposes. The database 118 is associated with the server 116. In general, database is a collection of information that is organized. In addition, database is easily accessed, managed and updated. In an embodiment of the present disclosure, the database 118 provides storage location to all data and information required by the video filtration system 114. In an embodiment of the present disclosure, the database 118 may be one of at least hierarchical database, network database, relational database, object-oriented database and the like. However, the database 118 is not limited to the above mentioned databases. In an example, the database 118 is connected with the server 116.

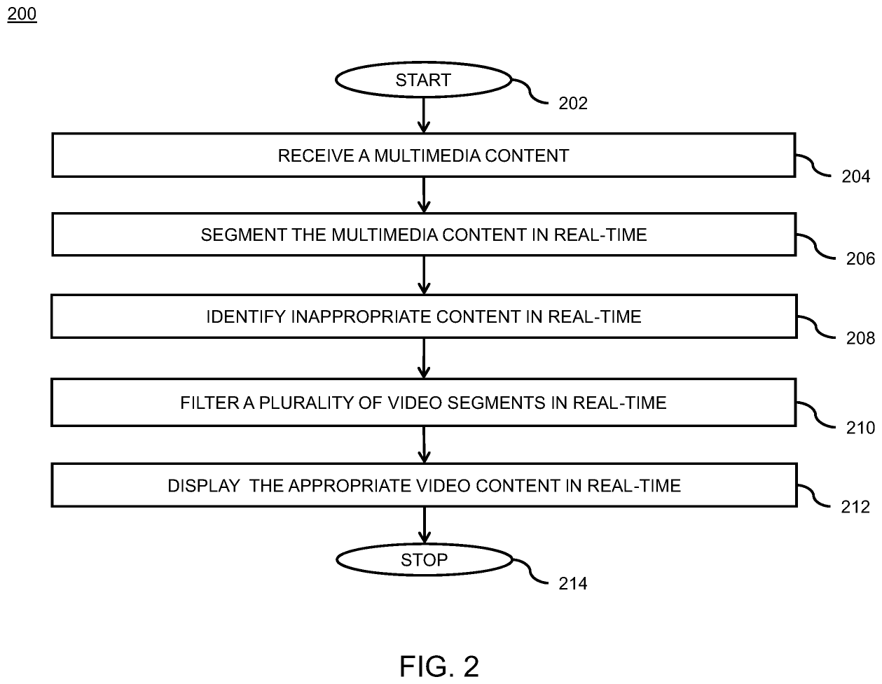

FIG. 2 illustrates a flow chart 200 of a method for real-time filtering of the inappropriate content from the plurality of video segments, in accordance with various embodiments of the present disclosure. It may be noted that to explain the process steps of flowchart 200, references will be made to the system elements of FIG. 1. It may also be noted that the flowchart 200 may have lesser or more number of steps.

The flow chart 200 initiates at step 202. Following step 202, at step 204, the video filtration system 114 facilitates reception of the one or more multimedia content 104 from the one or more input devices 102 in real-time. In addition, the one or more multimedia content 104 includes but may not be limited to text, audio and video. Further, the one or more input devices 102 includes but may not be limited to keyboard, joysticks and digital camera. Furthermore, the one or more input devices 102 extracts one or more multimedia content 104 from the one or more video sources. Moreover, the one or more video sources includes one or more databases. Also, the one or more databases includes but may not be limited to amazon web services, content distribution network, datacenters and one or more hardware devices crammed in server.

At step 206, the method includes segmentation of the one or more multimedia content 104 in real-time at the video filtration system 114. The video filtration system 114 creates the plurality of video segments from the one or more multimedia content 104 in real-time. In addition, the creation of the plurality of video segments from the one or more multimedia content 104 is done based the on one or more parameters. Further, the one or more parameters includes the audio continuity, the video continuity and the interaction of the audio continuity and the video continuity. Furthermore, the plurality of video segments is selected based the on one or more parameters.

At step 208, the method includes identification of the inappropriate content in real-time at the video filtration system 114. The video filtration system 114 identifies the inappropriate content from the plurality of video segments using machine learning algorithms.

At step 210, the method includes filtration of the plurality of video segments in real-time at the video filtration system 114. The video filtration system 114 filters out the inappropriate content using the detection model. In addition, the detection model filters the inappropriate content based on the one or more pre-defined factors. Also, the filtering of the inappropriate content from the plurality of video segments facilitates generation of the appropriate content.

At step 212, the method includes displaying the appropriate video content in real-time at the video filtration system 114. The video filtration system 114 displays the appropriate content on the one or more multimedia channels 110.

The flow chart 200 terminates at step 214. It may be noted that the flowchart 200 is explained to have above stated process steps; however, those skilled in the art would appreciate that the flowchart 200 may have more/less number of process steps which may enable all the above stated embodiments of the present disclosure.

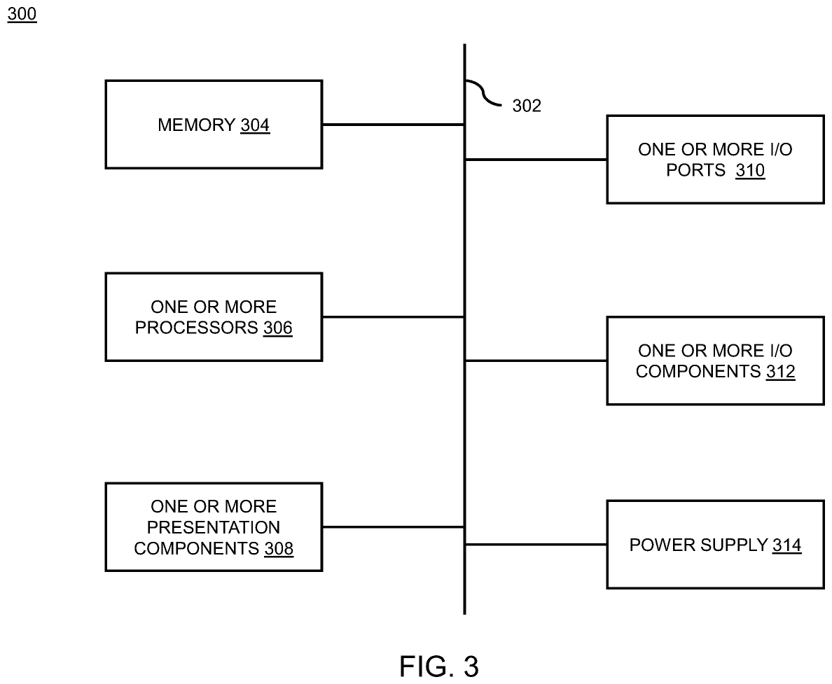

FIG. 3 illustrates a block diagram of a computing device 300, in accordance with various embodiments of the present disclosure. The computing device 300 is a non-transitory computer readable storage medium. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for real time filtering of an inappropriate content from a plurality of video segments, the method comprising:
receiving, at a video filtration system with a processor, one or more multimedia content, wherein the one or more multimedia content is received from one or more input devices;
segmenting, at the video filtration system with the processor, the one or more multimedia content in real-time, wherein the one or more multimedia content is segmented into the plurality of video segments, wherein the one or more multimedia content is segmented into the plurality of video segments based on one or more parameters, wherein the plurality of video segments is ranked based on the one or more parameters;
identifying, at the video filtration system with the processor, an inappropriate content in real-time, wherein the inappropriate content is identified from the plurality of video segments, wherein the inappropriate content is identified using machine learning algorithms;
filtering, at the video filtration system with the processor, the inappropriate content in real-time, wherein the inappropriate content is filtered out using a detection model, wherein the detection model filters the inappropriate content based on one or more pre-defined factors, wherein the filtering of the inappropriate content from the plurality of video segments facilitates generation of an appropriate video content; and
displaying, at the video filtration system with the processor, the appropriate video content in real-time, wherein the appropriate video content is displayed on one or more multimedia channels, wherein the appropriate video content is displayed based on one or more requirements of the one or more multimedia channels.

2. The computer-implemented method as recited in claim 1, wherein the one or more input devices comprising at least one of keyboard, joystick, mouse and digital camera.

3. The computer-implemented method as recited in claim 1, wherein the one or more multimedia content comprising at least one of text, audio, video, animation and graphics interface format (GIF).

4. The computer-implemented method as recited in claim 1, wherein the one or more parameters comprising an audio continuity, a video continuity and an intersection of the audio continuity and the video continuity.

5. The computer-implemented method as recited in claim 1, wherein the inappropriate content comprising nude video content, nude images, inappropriate audio content, violent video content, religiously disrespectful content, political influential content, cultural norms and gender discriminatory content.

6. The computer-implemented method as recited in claim 1, wherein the one or more pre-defined factors comprising at least one of geographical location, age and community.

7. The computer-implemented method as recited in claim 1, wherein the machine learning algorithms comprising at least one of linear regression, logistic regression, random forest, decision tree, and K-nearest neighbor.

8. The computer-implemented method as recited in claim 1, further comprising adaptive-learning of the detection model, at the video filtration system with the processor, wherein the detection model adaptively learns to filter-out the inappropriate content from the plurality of video segments based on training dataset.

9. The computer-implemented method as recited in claim 1, wherein the one or more requirements of the one or more multimedia channels comprising at least one of an orientation of the appropriate content, an aspect ratio of the appropriate content and a duration of the appropriate content.

10. The computer-implemented method as recited in claim 1, further comprising sub-filtering the plurality of video segments, at the video filtration system with the processor, wherein the sub-filtering of the plurality of video segments is effectuated to target a plurality of users at particular geographical location, wherein the sub-filtering is performed based on presence of naked-skin in the plurality of video segments.

11. A computer system comprising:
one or more processors; and
a memory coupled to the one or more processors, the memory for storing instructions which, when executed by the one or more processors, cause the one or more processors to perform a method for real time filtering of an inappropriate content from a plurality of video segments, the method comprising:
receiving, at a video filtration system, one or more multimedia content, wherein the one or more multimedia content is received from one or more input devices;
segmenting, at the video filtration system, the one or more multimedia content in real-time, wherein the one or more multimedia content is segmented into the plurality of video segments, wherein the one or more multimedia content is segmented into the plurality of video segments based on one or more parameters, wherein the plurality of video segments is ranked based on the one or more parameters;
identifying, at the video filtration system, an inappropriate content in real-time, wherein the inappropriate content is identified from the plurality of video segments, wherein the inappropriate content is identified using machine learning algorithms;
filtering, at the video filtration system, the inappropriate content in real-time, wherein the inappropriate content is filtered out using a detection model, wherein the detection model filters the inappropriate content based on one or more pre-defined factors, wherein the filtering of the inappropriate content from the plurality of video segments facilitates generation of an appropriate video content; and
displaying, at the video filtration system, the appropriate video content in real-time, wherein the appropriate video content is displayed on one or more multimedia channels, wherein the appropriate video content is displayed based on one or more requirements of the one or more multimedia channels.

12. The computer system as recited in claim 11, wherein the one or more input devices comprising at least one of keyboard, joystick, mouse and digital camera.

13. The computer system as recited in claim 11, wherein the one or more multimedia content comprising at least one of text, audio, video, animation and graphics interface format (GIF).

14. The computer system as recited in claim 11, wherein the one or more parameters comprising an audio continuity, a video continuity and an intersection of the audio continuity and the video continuity.

15. The computer system as recited in claim 11, wherein the inappropriate content comprising nude video content, nude images, inappropriate audio content, violent video content, religiously disrespectful content, political influential content, cultural norms and gender discriminatory content.

16. The computer system as recited in claim 11, wherein the one or more pre-defined factors comprising at least one of geographical location, age and community.

17. The computer system as recited in claim 11, wherein the machine learning algorithms comprising at least one of linear regression, logistic regression, random forest, decision tree, and K-nearest neighbor.

18. The computer system as recited in claim 11, further comprising adaptive-learning of the detection model, at the video filtration system, wherein the detection model adaptively learns to filter-out the inappropriate content from the plurality of video segments based on training dataset.

19. A non-transitory computer-readable storage medium encoding computer executable instructions that, when executed by at least one processor, performs a method for real time filtering of an inappropriate content from a plurality of video segments, the method comprising:
receiving, at a computing device, one or more multimedia content, wherein the one or more multimedia content is received from one or more input devices;
segmenting, at the computing device, the one or more multimedia content in real-time, wherein the one or more multimedia content is segmented into the plurality of video segments, wherein the one or more multimedia content is segmented into the plurality of video segments based on one or more parameters, wherein the plurality of video segments is ranked based on the one or more parameters;
identifying, at the computing device, an inappropriate content in real-time, wherein the inappropriate content is identified from the plurality of video segments, wherein the inappropriate content is identified using machine learning algorithms;
filtering, at the computing device, the inappropriate content in real-time, wherein the inappropriate content is filtered out using a detection model, wherein the detection model filters the inappropriate content based on one or more pre-defined factors, wherein the filtering of the inappropriate content from the plurality of video segments facilitates generation of an appropriate video content; and
displaying, at the computing device, the appropriate video content in real-time, wherein the appropriate video content is displayed on one or more multimedia channels, wherein the appropriate video content is displayed based on one or more requirements of the one or more multimedia channels.

20. The non-transitory computer-readable storage medium as recited in claim 19, further comprising adaptive-learning of the detection model, at the computing device, wherein the detection model adaptively learns to filter-out the inappropriate content from the plurality of video segments based on training dataset.
